(19) United States
(12) Patent Application Publication
(10) Pub. No.: US 2009/0009613 A1
(43) Pub. Date: Jan. 8, 2009

(54) Method for processing images and electronic device using the same

(75) Inventor: Yen-Lung Chien, Taipei (TW)

Correspondence Address: BACON & THOMAS, PLLC, 625 SLATERS LANE, FOURTH FLOOR, ALEXANDRIA, VA, 22314-1176, US

(73) Assignee: ASUSTek COMPUTER INC., Taipei (TW)

(21) Appl. No.: 12/216,009

(22) Filed: Jun. 27, 2008

(30) Foreign Application Priority Data
Jul. 2, 2007 (TW) 96124055

(51) Int. Cl. H04N 5/228

(52) U.S. Cl. 348/208.1; 348/E05.031

(57) ABSTRACT

A method for processing images and an electronic device using the same are provided, and the method includes the following steps. A plurality of pictures are successively captured in a frame. A shake parameter of each of the pictures relative to the preceding picture is analyzed. Each of the pictures is adjusted in the frame according to each of the shake parameters to allow the shake parameters to be close to zero. After each of the pictures is adjusted, it has at least a blank area in the frame. Each of the pictures has a boundary pattern adjacent to the blank area. Similar patterns for connecting the boundary patterns are searched for from a plurality of reference pictures. Afterwards, each of the similar patterns fills the corresponding each of the blank areas. The filled pictures are compressed. The compressed pictures are stored.

This application claims the benefit of Taiwan application Serial No. 96124055, filed Jul. 2, 2007, the subject matter of which is incorporated herein by reference.

### BACKGROUND OF THE INVENTION

1. Field of the Invention

The invention relates to a method for processing images and an electronic device using the same and, more particularly, to a method for processing images and decreasing shake of images and an electronic device using the same.

2. Description of the Related Art

A digital image can be permanently stored, does not occupy space and can be processed by a follow-up program. Then, the digital image gradually replaces an analog image (such as a negative, a roll film, etc.). A conventional digital video cameral is taken as an example to illustrate a follow-up method for processing images.

FIG. 1 is a schematic diagram showing a convention digital video camera 900 connected to a computer system 800. The digital video camera 900 includes an image capturing unit 910, a compression unit 960, a storage unit 970, a display unit 980 and a transmission port 990. After the image capturing unit 910 captures a digital image, the compression unit 960 compresses the captured digital image, and then the storage unit 970 stores the compressed digital image. A user can watch the stored digital image via the display unit 980. When the user takes a picture, movement of the user or a vehicle taken by the user or the shake of arms of the user causes the picture of the digital image to shake. When the user watches the stored digital image, the shaken picture causes the user to be uncomfortable.

If the user wants to process the stored digital image by a follow-up method, he may connect the transmission port 990 of the digital video camera 900 to the transmission port 890 of the computer system 800 via a transmission wire, and then the digital image is transmitted to the computer system 800 and is stored in the storage unit 870 of the computer system 800. The user can watch the stored digital image in the storage unit 870 through a display unit 880. Then, the user edits the digital image via the follow-up processing unit 810 of the computer system 800. Conventional follow-up processing programs executed by the computer system 800 include programs for deleting images, adding images, combining digital images, cutting digital images or recording voice. The conventional follow-up processing programs cannot decrease the shake of the pictures, and time and power are wasted.

### BRIEF SUMMARY OF THE INVENTION

The invention relates to a method for processing images and an electronic device using the same, and it decreases shake phenomena of pictures in a filling or enlarging mode.

According to the invention, a method for processing images is provided. The method for processing images includes the steps as follows. A plurality of pictures are successively captured in a frame. A shake parameter of each of the pictures relative to a preceding picture is analyzed. Each of the shake parameters includes a horizontal shift value, a vertical shift value and a rotation variety value. Each of the pictures is adjusted in the frame according to each of the shake parameters to allow the shake parameters of the adjusted pictures to be close to zero. After each of the pictures is adjusted, each of the adjusted pictures has at least a blank area in the frame. Each of the pictures has a boundary pattern, and the boundary pattern is adjacent to the blank area. Similar patters for connecting the boundary patterns are searched for from a plurality of reference pictures. The reference pictures are each of the pictures, a plurality of preceding pictures and a plurality of succeeding pictures. Each of the similar patterns fills the corresponding each of the blank areas. The filled pictures are compressed. The compressed pictures are stored.

According to another aspect of the invention, an electronic device is provided. The electronic device includes an image capturing unit, an analysis unit, an adjustment unit, a search unit, a filling unit, a compression unit and a storage unit. The image capturing unit is used for successively capturing a plurality of pictures in a frame. The analysis unit is used for analyzing a shake parameter of each of the pictures relative to a preceding picture. Each of the shake parameters includes a horizontal shift value, a vertical shift value and a rotation variety value. The adjustment unit is used for adjusting each of the pictures in the frame according to each of the shake parameters to allow the shake parameters to be close to zero. After each of the pictures is adjusted, each of the adjusted pictures has at least a blank area in the frame. Each of the pictures has a boundary pattern, and the boundary pattern is adjacent to the blank area. The search unit is used for searching for similar patters for connecting the boundary patterns from a plurality of reference pictures. The reference pictures are each of the pictures, a plurality of preceding pictures and a plurality of succeeding pictures. The filling unit is used for filling the corresponding each of the blank areas with each of the similar patterns. The compression unit is used for compressing each of the filled pictures. The storage unit is used for storing the compressed pictures.

According to the invention, a method for processing images is further provided. The method for processing images includes the steps as follows. A plurality of pictures are successively captured in a frame. A shake parameter of each of the pictures relative to a preceding picture is analyzed. Each of the shake parameters includes a horizontal shift value, a vertical shift value and a rotation variety value. Each of the pictures in the frame is adjusted according to each of the shake parameters to allow the shake parameters of the adjusted pictures to be close to zero. After each of the pictures is adjusted, each of the adjusted pictures has at least a blank area in the frame. Each of the pictures is cut with an overlap area, and the overlap area overlaps each of the adjusted pictures in the frame. The size of each of the cut pictures is enlarged to be the same with the size of the frame. The enlarged pictures are compressed. The compressed pictures are stored.

According to the invention, an electronic device is provided. The electronic device includes an image capturing unit, an analysis unit, an adjustment unit, a cutting unit, an enlarging unit, a compression unit and a storage unit. The image capturing unit is used for successively capturing a plurality of pictures in a frame. The analysis unit is used for analyzing a shake parameter of each of the pictures relative to a preceding picture. Each of the shake parameters includes a horizontal shift value, a vertical shift value and a rotation variety value. The adjustment unit is used for adjusting each of the pictures in the frame according to each of the shake parameters to allow the shake parameters to be close to zero. After each of the pictures is adjusted, each of the adjusted pictures has at least a blank area in the frame. The cutting unit cuts each of the pictures with an overlap area, and the overlap area overlaps each of the adjusted pictures in the frame. The enlarging unit is used for enlarging the size of each of the cut pictures to the size of the frame. The compression unit is used for compressing the enlarged pictures. The storage unit is used for storing the compressed pictures.

These and other features, aspects, and advantages of the present invention will become better understood with regard to the following description, appended claims, and accompanying drawings.

### BRIEF DESCRIPTION OF THE SEVERAL VIEWS OF THE DRAWINGS

FIG. 1 is a schematic diagram showing a convention digital video camera connected to a computer system;

FIG. 2 is a schematic diagram showing an electronic device according to the first embodiment of the invention;

FIG. 3 is a flow chart showing a method for processing images according to the first embodiment of the invention;

FIG. 4A to FIG. 4E are schematic diagrams showing pictures processed according to each of the steps shown in FIG. 3;

FIG. 5 is a schematic diagram showing an electronic device according to the second embodiment of the invention;

FIG. 6 is a flow chart showing a method for processing images according to the second embodiment of the invention; and

FIG. 7A to FIG. 7C are schematic diagrams showing picture processed according to each of the steps shown in FIG. 6.

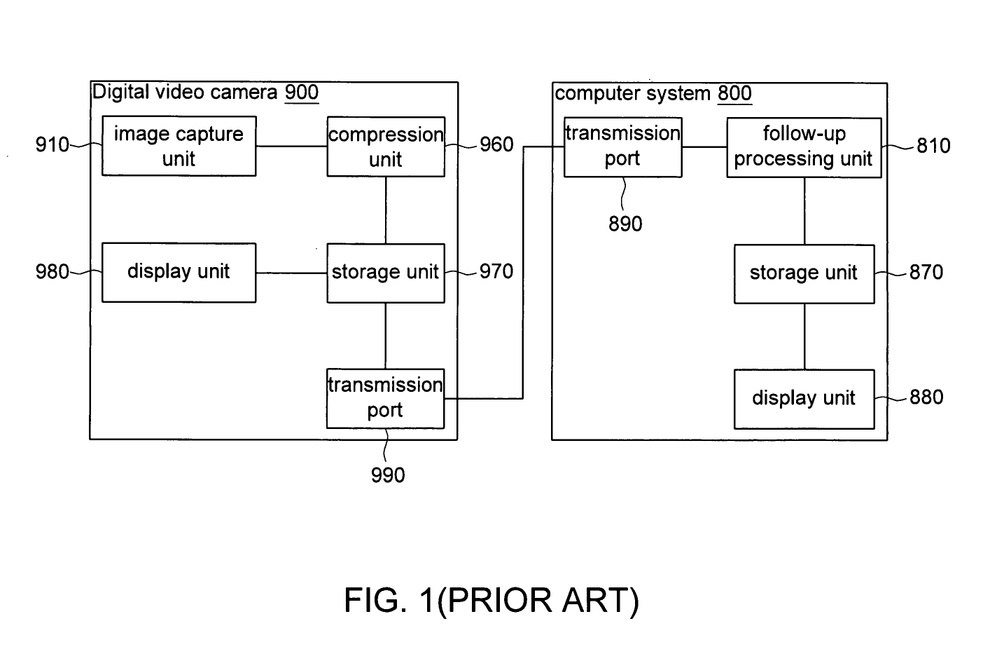

### DETAILED DESCRIPTION OF THE EMBODIMENTS

### First Embodiment

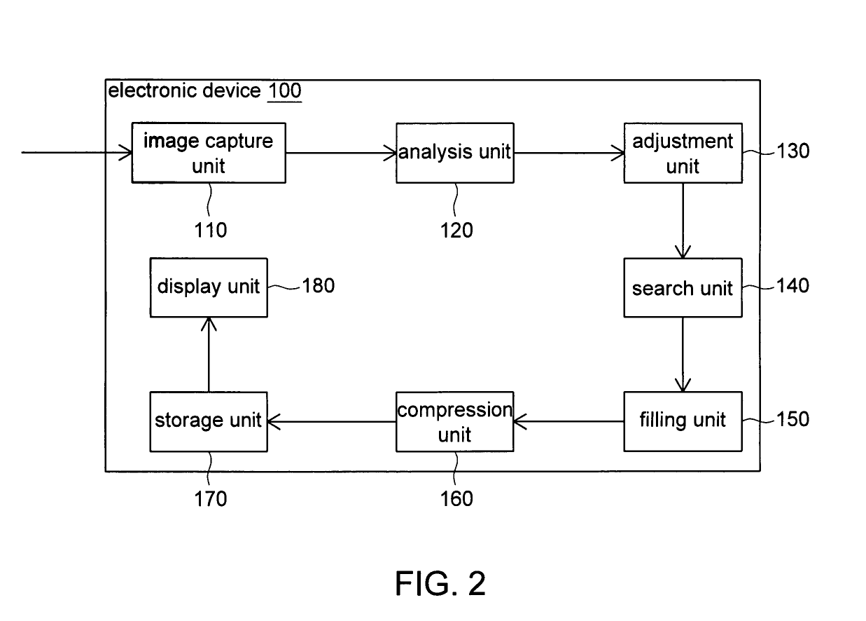

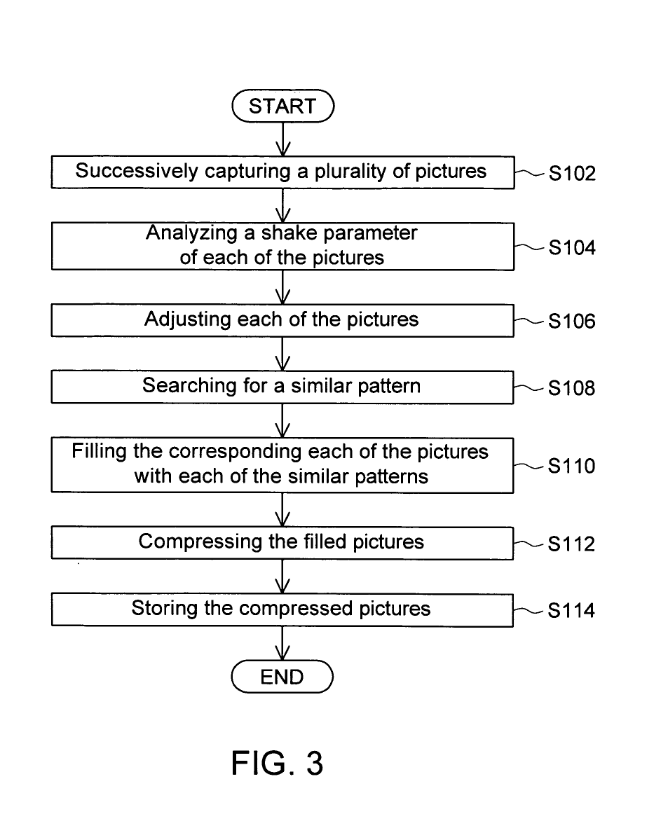

As shown in FIG. 2 and FIG. 3, FIG. 2 is a schematic diagram showing an electronic device 100 according to the first embodiment of the invention, and FIG. 3 is a flow chart showing a method for processing images according to the first embodiment of the invention. Although the method for processing images in the embodiment is applied to the electronic device 100 in FIG. 2, it is not limited. The method for processing images in the embodiment can be applied to other electronic devices.

As shown in FIG. 2, the electronic device 100 includes an image capturing unit 110, an analysis unit 120, an adjustment unit 130, a search unit 140, a filling unit 150, a compression unit 160, a storage unit 170 and a display unit 180. For example, the electronic device 100 is, a mobile phone, a digital camera or a digital video camera. The image capturing unit 110 is a charge coupled device (CCD) or a complementary metal-oxide-semiconductor optical sensor (CMOS optical sensor). The analysis unit 120, the adjustment unit 130, the search unit 140, the filling unit 150 and the compression unit 160 are independent chips, or they are integrated into one processing chip. The storage unit 170 is a memory which can be accessed. The display unit 180 is a liquid crystal display (LCD) or an organic light-emitting diode (OLED). To clearly illustrate the method for processing images in the embodiment, what follows is illustrated with drawings showing each of the steps of the method for processing images.

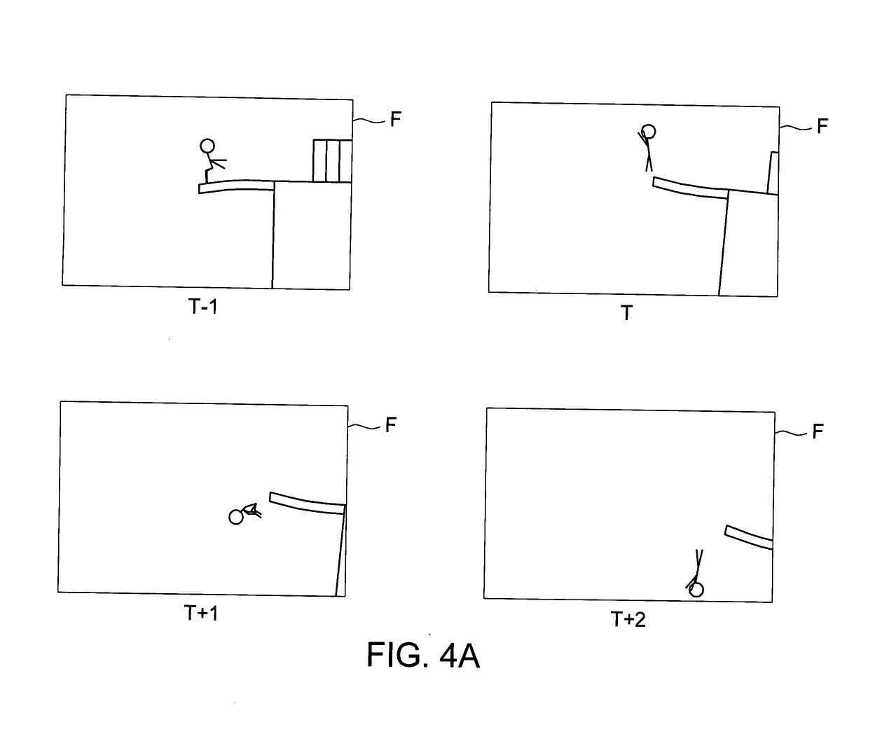

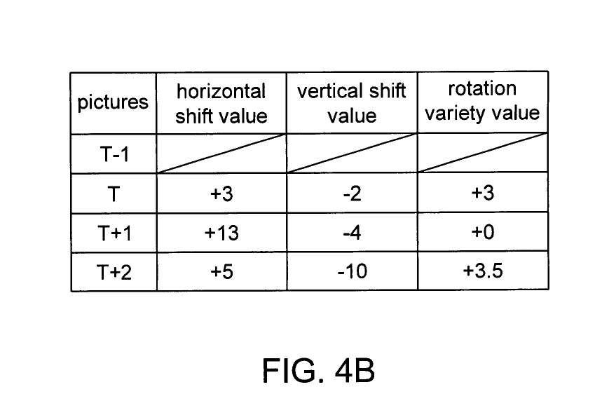

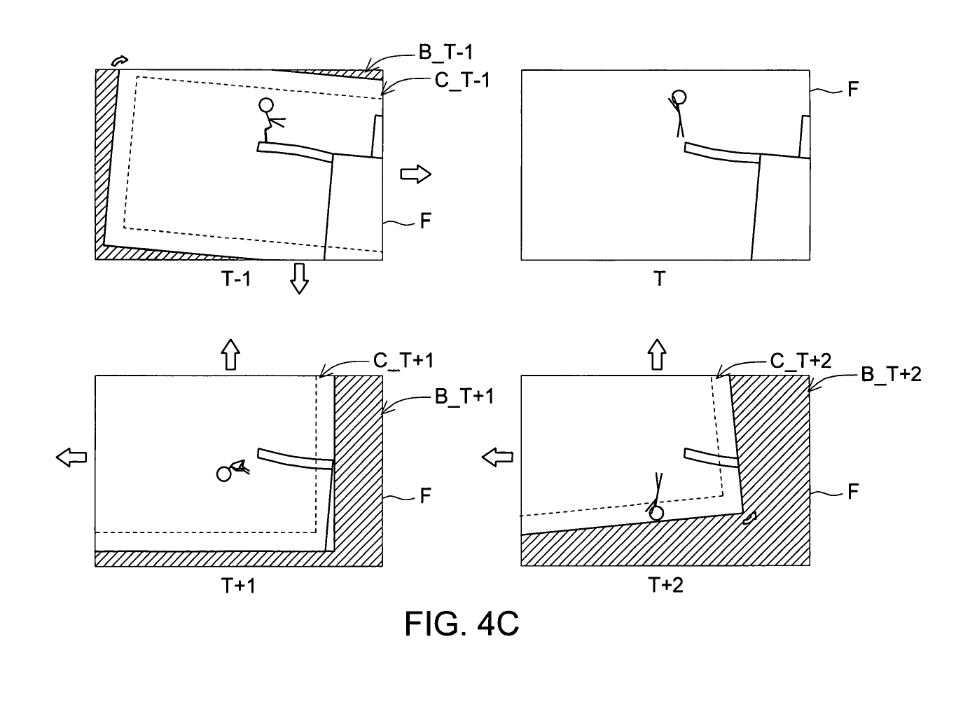

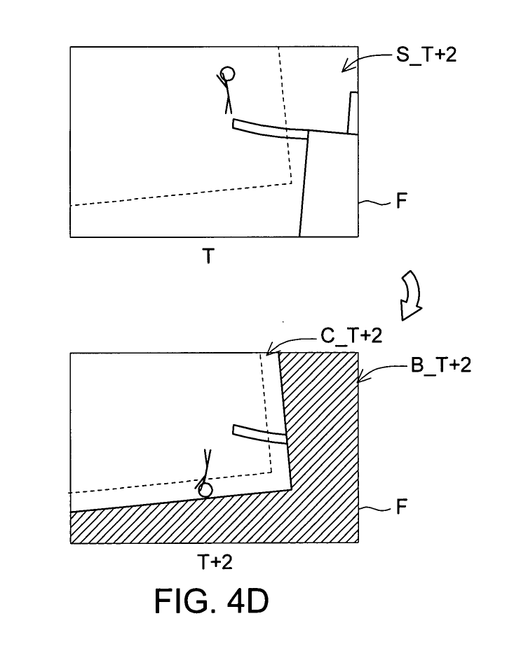

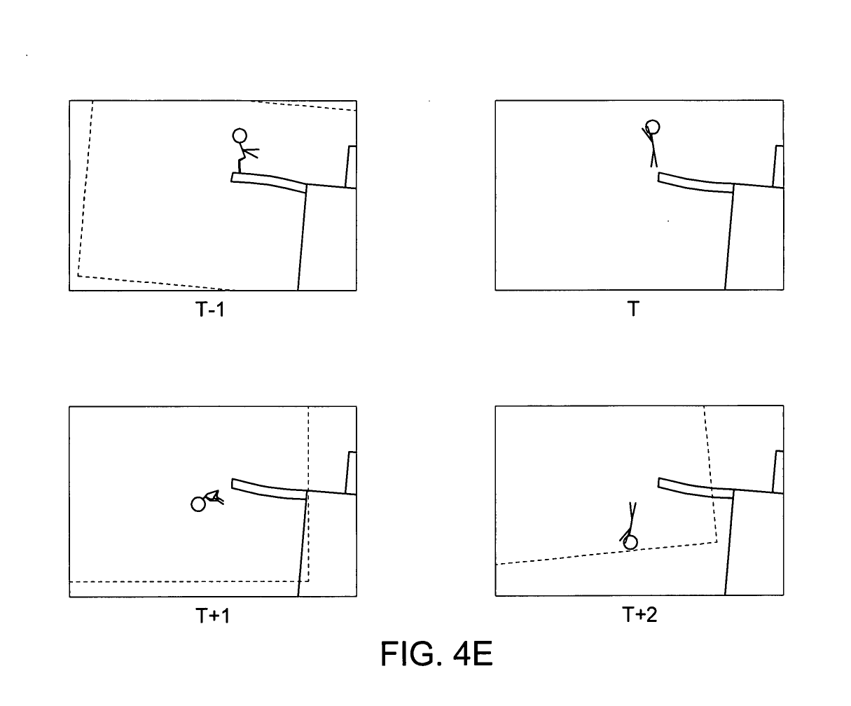

FIG. 4A to FIG. 4E are schematic diagrams showing pictures processed according to each of the steps in FIG. 3. As shown in FIG. 4A, in the step S102, the image capturing unit 110 successively captures a plurality of images in a frame F. The size of the frame F is a predetermined picture size of the electronic device 100. Generally speaking, the frame F is rectangular. When a user is traveling by some transportation, or his arm is shaking, each picture may have a slight displacement or rotation relative to a preceding picture. As shown in the T−1th to T+2th pictures, each of the pictures has a slight displacement or a rotation phenomenon.

Next, as shown in FIG. 4B, in the step S104, the analysis unit 120 analyzes a shake parameter of each of the pictures relative to a preceding picture. Each of the shake parameters includes a horizontal shift value, a vertical shift value and a rotation variety value. As a data chart shown in FIG. 4B, compared with the T−1th picture, the Tth picture is translated by positive three pixels in the horizontal direction, negative two pixels in the vertical direction, and positive three degree in rotation (assume that the right direction and the clockwise direction are positive directions). Compared with the Tth picture, the T+1th picture is translated by positive thirteen pixels in the horizontal direction, negative four pixels in the vertical direction, and zero degree in rotation. Compared with the T+1th picture, the T+2th picture is translated by positive five pixels in the horizontal direction, negative ten pixels in the vertical direction, and positive three point five degrees in rotation. As a whole, it likes that one object in a picture is gradually translated toward the bottom-right and rotated clockwise.

As shown in FIG. 4C, in the step S106, the adjustment unit 130 adjusts each of the pictures in the frame F according to each of the shake parameters to allow the shake parameters of the pictures to be close to zero. In the embodiment, after each of the pictures is translated in the horizontal direction, the vertical direction or rotation, the shake parameters of the pictures may be close to zero. Taking the Tth picture as a criterion, after the T−1th picture is translated by positive three pixels in the horizontal direction, negative two pixels in the vertical direction and positive three degrees in rotation, the T−1th picture has a blank area B_T−1 in the frame. After the T+1th picture is translated by negative thirteen pixels in the horizontal direction and positive four pixels in the vertical direction, the T+1th picture has a blank area B_T+1 in the frame. After the T+2th picture is translated by negative eighteen pixels in the horizontal direction, positive fourteen pixels in the vertical direction, and negative three point five degrees in rotation, the T+2th picture has a blank area B_T+2 in the frame. The pictures have boundary patterns C_T−1,C_T+1 and C_T+2, respectively, and the boundary patterns C_T−1,C_T+1 and C_T+2 are patterns adjacent to the blank areas B_T−1,B_T+1 and B_T+2, respectively.

In the step S108, the search unit 130 searches for similar patterns for connecting the boundary patterns C_T−1,C_T+1 and C_T+2 from a plurality of reference pictures. The reference pictures are each of the pictures, a plurality of the preceding pictures and a plurality of the succeeding pictures. In the embodiment, the reference pictures are each of the pictures, the thirty preceding pictures and the thirty succeeding pictures (taking the T+2th picture as an example, the reference pictures are the T−28th to T+32th pictures). That is, each of the pictures in the embodiment has sixty-one reference pictures.

The search unit 130 compares outlines of the reference pictures to search for each of the similar patterns. During the comparison process, if patterns similar to the outlines are found, but they cannot be used to connect the boundary patterns, the reference pictures can be enlarged, reduced, translated or rotated to be compared until the similar patterns for connecting the boundary patterns are found. Especially, when a user travels by a moving vehicle, patterns in the pictures are continuously enlarged or reduced along with the variety of the distance. The comparison efficiency increases by enlarging, reducing, translating or rotating the reference pictures.

In the step S108, the search unit 130 can rapidly search out each of the similar patterns from the reference pictures according to the change tendency of each of the shake parameters. Taking the embodiment as an example, the T−1th to T+2th pictures has a change tendency of gradually moving toward the bottom-right and rotating clockwise. The search unit 130 can rapidly search out the similar patterns according to the change tendency. As shown in FIG. 4D, the similar pattern S_T+2 corresponding to the absent pattern of the blank area B_T+2 at the bottom-right of the T+2th picture can be rapidly searched out from the corresponding position of the preceding Tth picture.

As shown in FIG. 4E, in the step S110, the filling unit 150 fills the corresponding each of the blank areas with each of the similar patterns. After each of the pictures is filled, each of the pictures does not have any blank area, and then the pictures are combined to be successive images which are stable and do not shake.

In the step S110, the filling unit 150 can further correspondingly adjust the color and the brightness of each of the similar patterns according to the color and the brightness of each of the boundary patterns to allow the pictures to be smoothly connected.

In the step S112, the compression unit 160 compresses the filled pictures.

In the step S114, the storage unit 170 stores the compressed pictures. Therefore, the electronic device 100 can automatically finish the processing program for stabilizing the pictures before it compresses or stores the pictures. The user can watch the digital images which do not shake on the display unit 180 of the electronic device 100. Thus, the convenience in use greatly increases.

### Second Embodiment

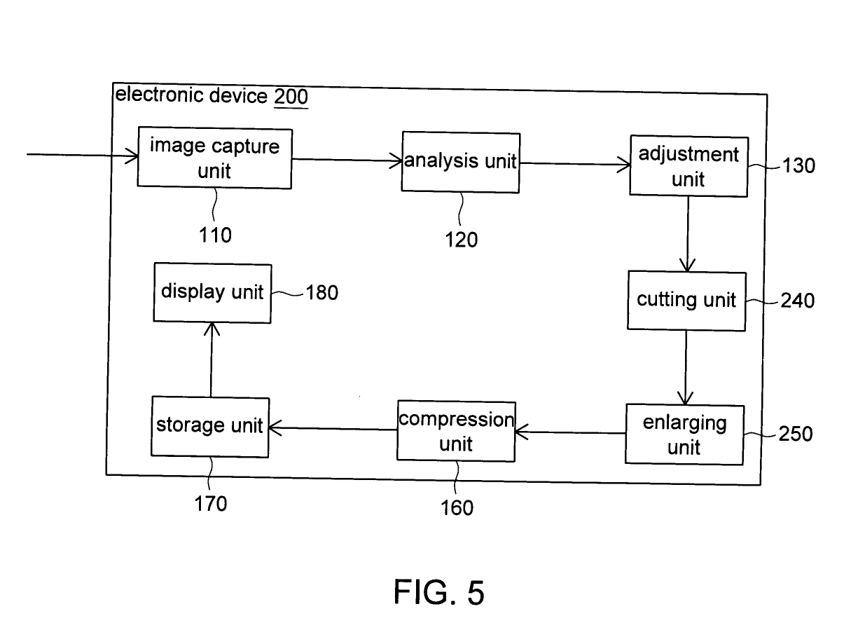

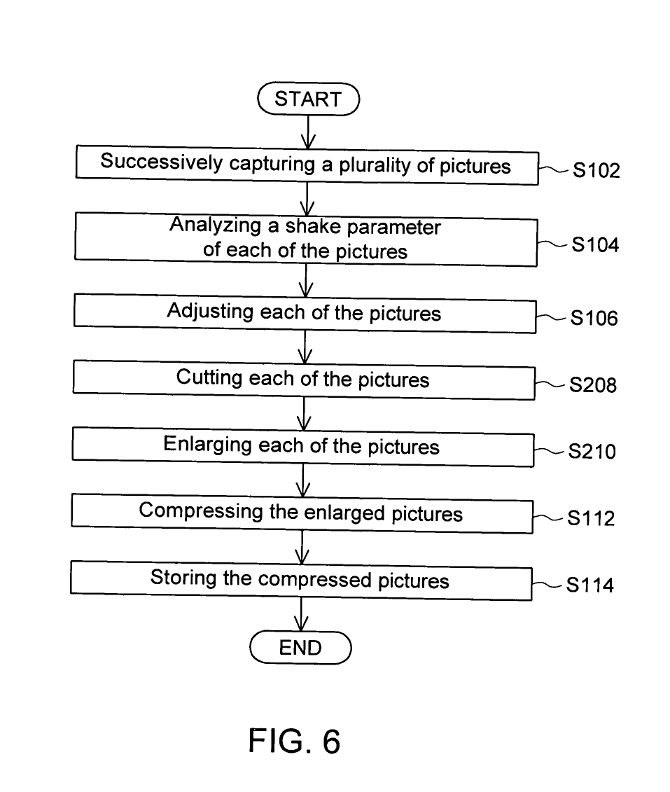

The difference between a method for processing images and an electronic device 200 using the same of the embodiment and the method for processing images and the electronic device 100 using the same of the first embodiment is the program for filling the blank areas, and other same content is not described for concise purpose. As shown in FIG. 5 and FIG. 6, FIG. 5 is a schematic diagram showing the electronic device 200 according to the second embodiment of the invention, and FIG. 6 is a flow chart showing the method for processing images according to the second embodiment of the invention. The electronic device 200 includes an image capturing unit 110, an analysis unit 120, an adjustment unit 130, a cutting unit 240, an enlarging unit 250, a compression unit 260, a storage unit 170 and a display unit 180. For example, the analysis unit 120, the adjustment unit 130, the cutting unit 240 and the enlarging unit 250 are independent chips, or they are integrated into one single processing chip. To clearly illustrate the method for processing images in the embodiment, the method for processing images is illustrated with drawings showing each of the steps of the method for processing images.

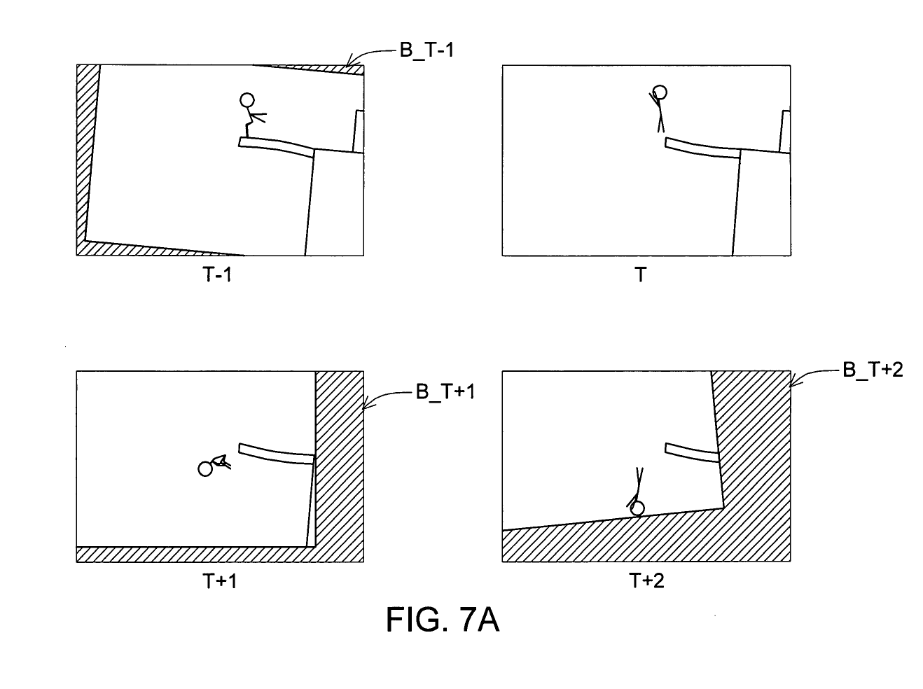

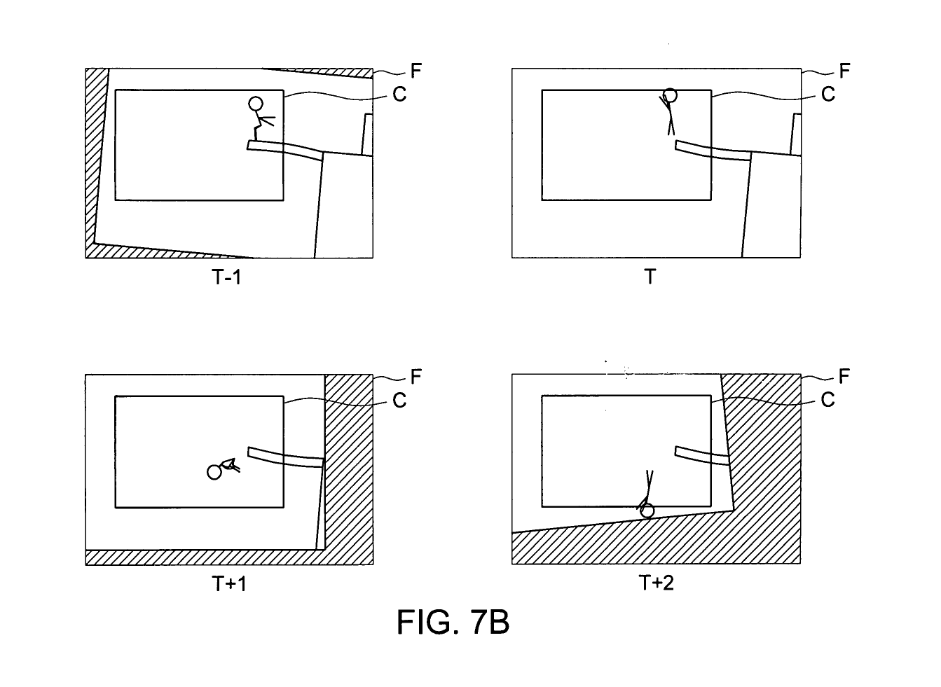

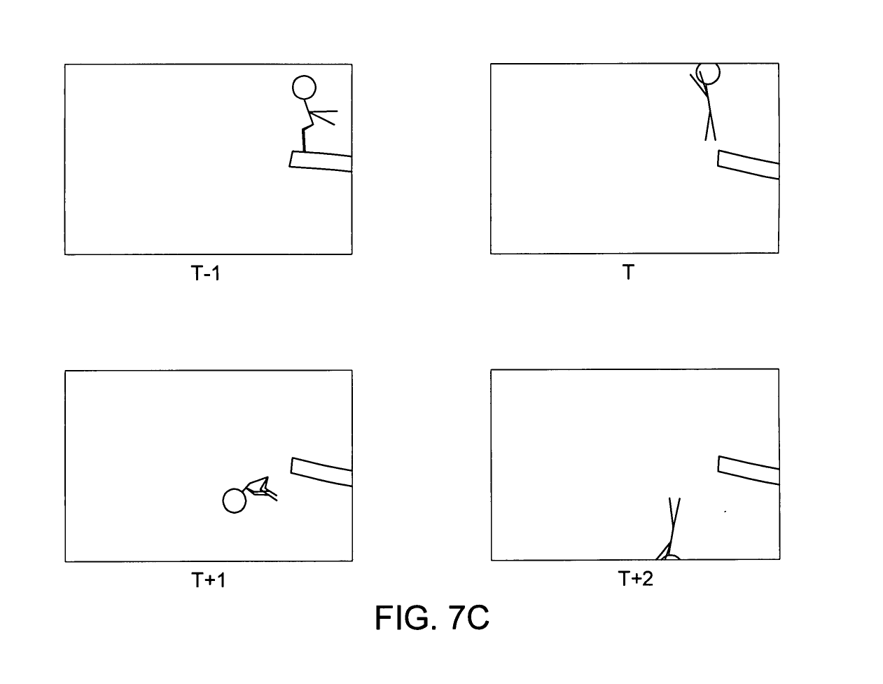

FIG. 7A to FIG. 7C are schematic diagrams showing pictures processed according to each of the steps shown in FIG. 6. As shown in FIG. 7A, after the steps S102 to S106 are executed, each of the pictures which are translated in the horizontal or vertical direction or rotated has at least a blank area in the frame.

As shown in FIG. 7B, in the step S208, the cutting unit 240 cuts each of the pictures with an overlap area C. The overlap area C overlaps each of the pictures which is translated in the horizontal or vertical direction or rotated in the frame F. That is, the overlap area C is the largest area having a pattern (not the blank area) of each of the pictures. The overlap area C of the embodiment and the frame F are similar rectangles, and the width and length of the overlap area C is reduced with the same ratio.

As shown in FIG. 7C, in the step S210, the enlarging unit 250 enlarges the size of each of the cut pictures to the size of the frame F. After each of the pictures is enlarged, each of the pictures does not have any blank area. Then, the pictures are combined to be successive images which are stable and do not shake.

In the steps S112 to S114, the stabilized pictures are compressed and stored.

The method for processing images and the electronic device using the same disclosed in the embodiment of the invention utilize a filling or enlarging mode to decrease the shake phenomenon of each of the pictures. The method for processing images and the electronic device using the same have the following advantages.

First, the shaking phenomenon of each of the pictures can be effectively improved to allow users to watch the images comfortably.

Second, if a filling mode is used to stabilize the pictures, the pictures can remain their original sizes, and captured objects cannot be lost.

Third, during the comparison process for searching for the similar patterns, if patterns having similar outlines are searched out, but they cannot be used to connect the boundary patterns, the reference pictures can be enlarged, reduced, translated or rotated to be compared until the similar patterns which can be used to connect the boundary patterns are found. Especially, when a user travels by a moving vehicle, patterns in the pictures are continuously enlarged or reduced along with the variety of the distance. The comparison efficiency increases by enlarging, reducing, translating or rotating the reference pictures.

Fourth, the search unit can rapidly search out the similar patterns according to the change tendency of the pictures.

Fifth, the filling unit can further correspondingly adjust the color and the brightness of each of the similar patterns according to the color and the brightness of each of the boundary patterns to allow the pictures to be smoothly connected.

Sixth, if an enlarging mode is used to stabilize the pictures, the operation complexity decreases, the memory occupies little, and the processing speed is high.

Seventh, in the method for processing images in the above embodiment, a program is executed for stabilizing the pictures before the images are compressed and stored to the electronic device. Then, a user can directly watch stable images on the electronic device without any follow-up processing program.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A method for processing images comprising the steps of:
successively capturing a plurality of pictures in a frame;
analyzing a shake parameter of each of the pictures relative to a preceding picture, wherein each of the shake parameters comprises a horizontal shift value, a vertical shift value and a rotation variety value;
adjusting each of the pictures in the frame according to each of the shake parameters to allow the shake parameters of the adjusted pictures to be close to zero, wherein after each of the pictures is adjusted, each of the adjusted pictures has at least a blank area in the frame, each of the pictures has a boundary pattern, and the boundary pattern is adjacent to the blank area;
searching for a similar pattern for connecting each of the boundary patterns from a plurality of reference pictures, wherein the reference pictures are each of the pictures, a plurality of preceding pictures and a plurality of succeeding pictures thereof;
filling the corresponding each of the blank areas with each of the similar patterns;
compressing the filled pictures; and
storing the compressed pictures.

2. The method for processing images according to claim 1, wherein in the step of adjusting each of the pictures in the frame according to each of the shake parameters, each of the pictures is horizontally translated, vertically translated or rotated.

3. The method for processing images according to claim 1, wherein in the step of searching for each of the similar patterns, outlines of the reference pictures are compared to search for the similar patterns.

4. The method for processing images according to claim 3, wherein in the step of searching for each of the similar patterns, the reference pictures are enlarged, reduced, translated or rotated to compare with the outlines thereof to search for the similar patterns.

5. The method for processing images according to claim 1, wherein in the step of searching for each of the similar patterns, each of the similar patterns is searched for from the reference pictures according to a change tendency of each of the shake parameters.

6. The method for processing images according to claim 1, wherein the reference pictures are each of the pictures, the thirty preceding pictures and the thirty succeeding pictures.

7. The method for processing images according to claim 1, wherein in the step of filling each of the blank areas, the color and brightness of each of the similar patterns are correspondingly adjusted according to the color and brightness of each of the boundary patterns.

8. An electronic device comprising:
an image capturing unit for successively capturing a plurality of pictures in a frame;
an analysis unit for analyzing a shake parameter of each of the pictures relative to the preceding picture, wherein each of the shake parameters comprises a horizontal shift value, a vertical shift value and a rotation variety value;
an adjustment unit for adjusting each of the pictures in the frame according to each of the shake parameters to allow the shake parameters to be close to zero, wherein after each of the pictures is adjusted, each of the adjusted pictures has at least a blank area in the frame, each of the pictures has a boundary pattern, and the boundary pattern is adjacent to the blank area;
a search unit for searching for similar patters for connecting the boundary patterns from a plurality of reference pictures, wherein the reference pictures are each of the pictures, a plurality of preceding pictures and a plurality of succeeding pictures thereof;
a filling unit for filling the corresponding each of the blank areas with each of the similar patterns;
a compression unit for compressing the filled pictures; and
a storage unit for storing the compressed pictures.

9. The electronic device according to claim 8, wherein the adjustment unit horizontally translates, vertically translates or rotates each of the pictures according to each of the shake parameters.

10. The electronic device according to claim 8, wherein the search unit compares outlines of the reference pictures to search for the similar patterns.

11. The electronic device according to claim 10, wherein the search unit compares the outlines of the reference pictures by enlarging, reducing, horizontally translating or rotating the reference pictures to search for each of the similar patterns.

12. The electronic device according to claim 8, wherein the search unit searches for each of the similar patterns from the reference pictures according to the change tendency of each of the shake parameters.

13. The electronic device according to claim 8, wherein the reference pictures are each of the pictures, the thirty preceding pictures and the thirty succeeding pictures.

14. The electronic device according to claim 8, wherein the filling unit adjusts the color and brightness of each of the similar patterns according to the color and brightness of each of the boundary patterns.

15. The electronic device according to claim 8, wherein the electronic device is a mobile phone, a digital camera or a digital video camera.

16. A method for processing images comprising the steps of:
successively capturing a plurality of pictures in a frame;
analyzing a shake parameter of each of the pictures relative to the preceding picture, wherein each of the shake parameters comprises a horizontal shift value, a vertical shift value and a rotation variety value;
adjusting each of the pictures in the frame according to each of the shake parameters to allow the shake parameters of the adjusted pictures to be close to zero, wherein after each of the pictures is adjusted, each of the adjusted pictures has at least a blank area in the frame;
cutting each of the pictures with an overlap area, wherein the overlap area overlaps each of the adjusted pictures in the frame;
enlarging the size of each of the cut pictures to the size of the frame;
compressing the enlarged pictures; and
storing the compressed pictures.

17. The method for processing images according to claim 16, wherein the shape of the overlap area is similar to the shape of the frame.

18. An electronic device comprising:
an image capturing unit for successively capturing a plurality of pictures in a frame;
an analysis unit for analyzing a shake parameter of each of the pictures relative to the preceding picture, wherein each of the shake parameters comprises a horizontal shift value, a vertical shift value and a rotation variety value;
an adjustment unit for adjusting each of the pictures in the frame according to each of the shake parameters to allow the shake parameters to be close to zero, wherein after each of the pictures is adjusted, each of the adjusted pictures has at least a blank area in the frame;
a cutting unit for cutting each of the pictures with an overlap area, wherein the overlap area overlaps each of the adjusted pictures in the frame;
an enlarging unit for enlarging the size of each of the cut pictures to the size of the frame;
a compression unit for compressing the enlarged pictures; and
a storage unit for storing the compressed pictures.

19. The electronic device according to claim 18, wherein the shape of the overlap area is similar to the shape of the frame.

20. The electronic device according to claim 18, wherein the electronic device is a mobile phone, a digital camera or a digital video camera.
